(19) United States
(12) Patent Application Publication
(10) Pub. No.: US 2026/0302765 A1
(43) Pub. Date: Oct. 1, 2026

(54) Apparatus and Methods Preventing Circuit Breaker Masking

(71) Applicant: Achim Ginsberg-Klemmt, Sarasota, FL (US)

(72) Inventor: Achim Ginsberg-Klemmt, Sarasota, FL (US)

(21) Appl. No.: 19/091,352

(22) Filed: Mar. 26, 2025

(51) Int. Cl. H02H 9/02; H02G 3/08; H02H 1/00

(52) U.S. Cl. CPC H02H 9/02; H02G 3/081; H02H 1/0007

(57) ABSTRACT

A system has a junction box, a receptacle mounted to the junction box, a current limiting device, an incoming phase wire, an incoming neutral wire, an outgoing phase wire, coupled to the incoming phase wire at a first junction, an outgoing neutral wire exiting the junction box, coupled to the incoming neutral wire at a second junction, a first current sensor; and control circuitry coupled to the current sensor. The incoming terminal of the current limiting device may be connected to the phase terminal of the receptacle and the outgoing terminal of the current limiting device may be connected to the first junction with the current sensor associated with the outgoing phase wire, the control circuitry controlling the current limiting device to keep sensed current below a threshold.

### BACKGROUND OF THE INVENTION

### 1. Field of the Invention

The present invention is in the technical field of residential and commercial electrical power generation and distribution and pertains more particularly to preventing circuit breaker masking.

### 2. Description of Related Art

Circuit breaker masking is a safety hazard in power distribution systems where individual circuits are protected by circuit breakers. This issue arises when distributed energy resources (DERs), such as balcony solar units, portable solar generation devices and plug-in batteries, supply electricity locally within a breaker protected circuit. DERs feeding electricity into the protected circuit can reduce the current measured by the circuit breaker, potentially allowing hazardous overloading of wiring without triggering a breaker trip.

Standard circuit breakers are designed to interrupt power when the total current flowing through the protected circuit exceeds the breaker's rated capacity. However, when a plug-in DER injects power into the circuit, it offsets the current drawn from the main panel, leading the circuit breaker to register a lower net current. As a result, the breaker may fail to detect an actual overload condition occurring in portions of the wiring that carry excess current. In severe cases, this can lead to overheating, insulation degradation, and fire hazards, particularly in non-dedicated circuits shared by multiple loads and plug-in generators.

The increasing adoption of plug-in DERs, particularly in residential settings where users connect such devices to standard wall receptacles, amplifies the risks associated with circuit breaker masking. Existing protective mechanisms in conventional circuit breakers do not account for local power injection, necessitating improved solutions to ensure electrical safety in circuits incorporating plug-in DERs.

### BRIEF SUMMARY OF THE INVENTION

In one embodiment of the invention a system is provided, comprising a junction box, at least one receptacle mounted to the junction box having a phase terminal and a neutral terminal, a current limiting device having an input and an output terminal, an incoming phase wire entering the junction box, an incoming neutral wire entering the junction box, an outgoing phase wire exiting the junction box, coupled to the incoming phase wire at a first junction, an outgoing neutral wire exiting the junction box, coupled to the incoming neutral wire at a second junction, a first current sensor, and control circuitry coupled to the first current sensor, wherein the incoming terminal of the current limiting device is connected to one of the phase terminal and the neutral terminal of the at least one receptacle, the outgoing terminal of the current limiting device is connected to one of the first and the second junctions, and the first current sensor is associated with one of the outgoing phase wire and the outgoing neutral wire, and wherein the control circuitry, upon sensing a current by the current sensor above a preprogrammed threshold sends a signal to one of the current limiting devices, a distributed energy resource (DER) plugged into the at least one receptacle and a remotely operable circuit breaker.

In one embodiment the incoming terminal of the current limiting device is connected to the phase terminal of the receptacle, the outgoing terminal of the current limiting device is connected to the first junction, and the first current sensor senses current in the outgoing phase wire. Also, in one embodiment the DER is remotely operable, and wherein the control circuitry, upon sensing a current above a preprogrammed threshold sends a signal to the DER to reduce current until the sensed current above a preprogrammed threshold is at or below the preprogrammed threshold. Also, in one embodiment the current limiting device is a device that limits current in an analog manner, and the control circuitry upon sensing a current above a preprogrammed threshold sends a signal to the current limiting device to reduce the current to a value below the preprogrammed threshold. And in one embodiment the current limiting device is a normally closed contact, and the control circuitry upon sensing a current above a preprogrammed threshold sends a signal to the current limiting device to open the normally closed contact.

In one embodiment, upon sensing a current above a preprogrammed threshold, the control circuitry transmits an electromagnetic signal to open a remotely operable circuit breaker. Also, in one embodiment the incoming terminal of the current limiting device is connected to the neutral terminal of the receptacle, the outgoing terminal of the current limiting device is connected to the second junction, and the first current sensor senses current in the outgoing neutral wire. Also, in one embodiment the current limiting device is a device that limits current in an analog manner, and the control circuitry upon sensing a current above a preprogrammed threshold sends a signal to the current limiting device to reduce the current to a value below the preprogrammed threshold. In one embodiment the current limiting device is a normally closed contact, and the control circuitry upon sensing a current above a preprogrammed threshold sends a signal to the current sensing device to open the normally closed contact. And in one embodiment, upon sensing a current above a preprogrammed threshold, the control circuitry transmits a signal to open the remotely operable breaker.

In one embodiment the system further comprises a conductive phase bus with the incoming phase wire, the outgoing phase wire and a wire to the output terminal of the current limiting device all coupled to the phase bus. Also, in one embodiment the wires are coupled to the phase bus by solder.

In one embodiment the system further comprises a conductive neutral bus with the incoming neutral wire, the outgoing neutral wire and a wire to the output terminal of the current limiting device all coupled to the neutral bus. In one embodiment the wires are coupled to the neutral bus by solder. In one embodiment the system further comprises a second current sensor associated with one of the incoming phase wires and the incoming neutral wire. In one embodiment the first current sensor is a current transformer (CT). Also, in one embodiment the second current sensor is a current transformer (CT).

In one embodiment the at least one receptacle is a GFCI configured receptacle. Also, in one embodiment the control circuitry is configured to operate on one of several different voltage thresholds, including 15 amps, 20 amps, 30 amps and 40 amps, depending on the threshold of a circuit breaker powering the circuit. In one embodiment the control circuitry is programmable by wireless signals from a smartphone executing a mobile application, to operate on a single one of different voltage thresholds. And in one embodiment the control circuitry is programmable by a direct wire connection from a programming device, to operate on a single one of different voltage thresholds.

### BRIEF DESCRIPTION OF THE SEVERAL VIEWS OF THE DRAWINGS

FIG. 1 is a diagram of a breaker-protected circuit with DERs plugged into portions of the circuit in prior art.

FIG. 2 is a perspective view of a molded junction box in an embodiment of the present invention.

FIG. 3 illustrates a sensor and control unit in an embodiment of the invention.

FIG. 4 is a diagram of control circuitry in an embodiment of the invention.

FIG. 5A is a perspective view of a remotely operable circuit breaker I an embodiment of the invention.

FIG. 5B illustrates an operable unit in the circuit breaker of FIG. 5A.

FIG. 6 is a perspective view of a breaker masking preventer (BMP) in an embodiment of the present invention.

FIG. 7 is a perspective view of BMP 601 with front panel 603 removed.

FIG. 8 is a diagram of control circuitry in one embodiment of the invention.

FIG. 9 illustrates a smartphone executing a mobile application in an embodiment of the invention.

### DETAILED DESCRIPTION OF THE INVENTION

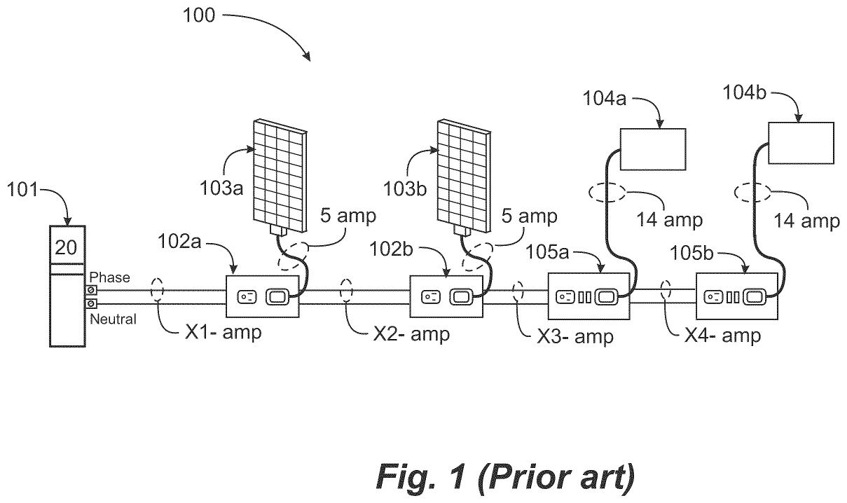

FIG. 1 illustrates a breaker-protected circuit 100 in prior art, where distributed energy resources (DERs) 103a and 103b are plugged into various points along the circuit.

A skilled artisan will understand that the DERs depicted in FIG. 1 may comprise one or several PV modules and can be substituted with plug-in electricity storage devices like batteries, capacitors and other devices. In this example, circuit 100 is safeguarded by a 20-amp circuit breaker 101.

At the first outlet 102a, a DER 103a, represented here as a solar-powered device, is plugged into one receptacle. Similarly, at a second outlet 102b, a DER 103b is connected, supplying 5 amps of current into circuit 100.

Further along distribution circuit 100, a protected outlet box 105a containing an internal breaker is present. A device 104a, plugged into one receptacle, draws a fixed 14 amps of current.

At the end of distribution circuit 100, another protected outlet box 105b is shown. A second device 104 b is plugged into one of its receptacles, also drawing a fixed 14 amps.

In this example, Circuit 100 is a 120V AC circuit, but the functionality would also work for other distribution grid voltages. A skilled person will recognize that breaker 101 provides two outlet contact points: one for the phase wire (Hot/Live/Line) and one for the neutral wire (Common/Zero).

A third wire, typically a ground wire, may also be present to connect portions of the circuit to ground for safety. However, in this example, only the phase and neutral wires are shown between outlet boxes. A skilled person will also understand that the cords for DERs 103a and 103b and loads 104a and 104b will include at least a phase wire and a neutral wire.

In the example of FIG. 1, the total load on the distribution circuit is 28 amps, which is the sum of the two 14-amp loads (104a and 104b). The current X4, flowing between protected outlets 105a and 105b, is 14 amps, while the current X3, between outlet 102b and protected outlet 105a, is 28 amps.

Of the 28 amps between outlet 102b and protected outlet 105a, 5 amps are supplied by DER 103b at outlet 102b. Consequently, the current X2, between outlets 102a and 102b, is 23 amps. Additionally, 5 amps of this 23-amp current is provided by DER 103a at outlet 102a, leaving the current X1, between breaker 101 and outlet 102a, at 18 amps—just below the 20-amp trip threshold of breaker 101.

The issue in this configuration is evident: while sections of the circuit carry 23 amps and 28 amps—both exceeding the breaker's 20-amp threshold. Breaker 101 itself only registers 18 amps and does not trip. As a result, the breaker fails to protect circuit 101, effectively becoming masked.

Furthermore, the section carrying 28 amps is at risk of overheating, potentially leading to failure or even a fire. This example highlights a critical challenge: while DERs can be beneficial, their placement within an existing circuit must be carefully managed to prevent hazardous conditions.

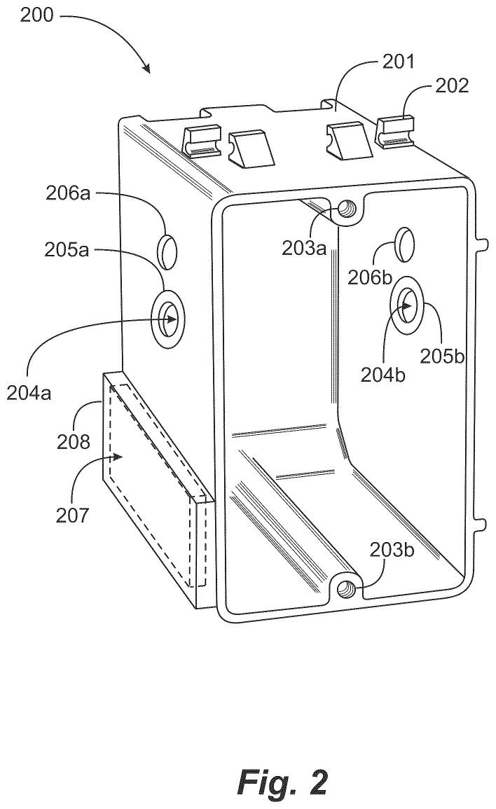

FIG. 2 is a perspective view of a molded “smart” junction box 200 in an embodiment of the present invention. In this example junction box 200 features a plastic molded body 201 with molded extensions 202 designed to accommodate nails or other fasteners for secure attachment to a wall stud or other wooden support.

This embodiment also includes threaded holes 203a and 203b for mounting a switch, such as an Enerlites 20-amp toggle light switch, or a duplex receptacle, such as the Leviton W5320-T0G model.

In this example, smart junction box 200 features two openings on opposite walls: opening 204a and opening 204b. Opening 204a houses a current transformer (CT) 205a, while opening 204b contains CT 205b. Additionally, the junction box includes two unused openings, 206a and 206b, on opposite walls, intended for neutral wires.

Rather than relying on current transformers (CTs) for current measurement, alternative devices such as Hall sensors may also be effectively used in BMPs.

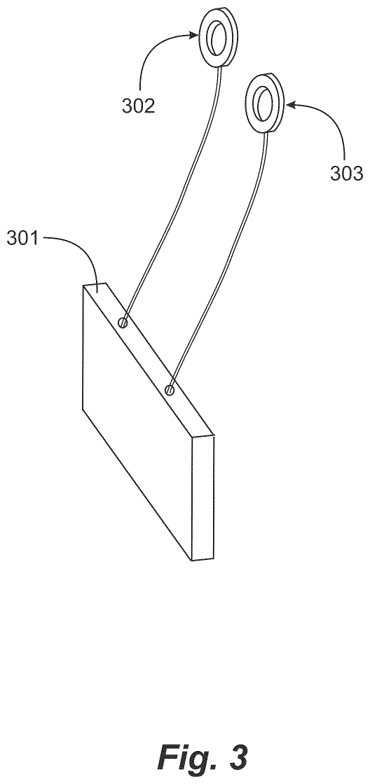

CTs 205a and 205b each have dual leads that connect to control circuitry 207, which is housed in a molded pocket 208. While FIG. 2 does not show the CT leads or the components of control circuitry 207, these elements are illustrated in FIG. 3 and described below.

In this configuration, opening 204a is for the phase-in wire, which may originate from a circuit breaker or another junction box. Conversely, opening 204b accommodates the phase-out wire, which may lead to another junction box. The unused openings 206a and 206b are intended for the corresponding neutral wires entering and exiting junction box 200.

A skilled artisan will recognize that junction box 200 represents just one possible implementation of a smart junction box. While this example describes a plastic enclosure, the box may also be metal, and the placement of openings may vary. Similarly, control circuitry 207 may be integrated into a molded wall, housed in a designated pocket, or accessible via a removable panel. The CT wiring may be embedded within the walls, affixed to interior surfaces, or left loose inside the junction box. These design variations illustrate flexibility in adapting smart junction boxes to different applications. Beyond the example above, in one embodiment, the control circuitry with CTs may be housed in a standalone package, separate from the junction box. In this configuration, neither the control circuitry nor the CTs are physically attached to the junction box, allowing the unit to be used with any conventional junction box.

FIG. 3 illustrates this embodiment, where control circuit 301 is connected to CTs 302 and 303 via wire connectors. In this setup, a user can open a junction box, disconnect the incoming phase line, pass it through CT 302, and reconnect it to the receptacle or switch mounted to the junction box. Likewise, the outgoing phase line can be disconnected, passed through CT 303, and then reconnected to the switch or plug. This design enables easy integration into existing junction boxes, enhancing flexibility and adaptability for various applications.

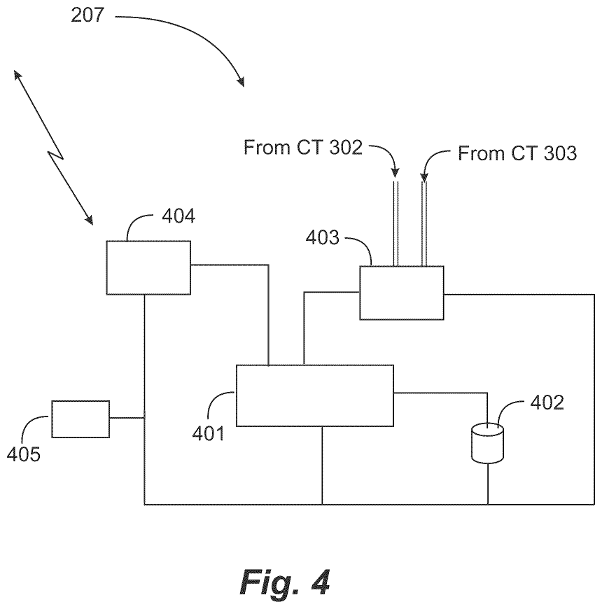

FIG. 4 illustrates an embodiment of control circuitry 207. A processor 401 is connected to a digital data repository 402, which stores data and coded instructions. A comparison circuit 403, linked to CTs 302 and 303, compares their input and transmits the results to processor 401. Additionally, wireless transmission circuitry 404 enables communication with remote systems under the control of processor 401. The system is powered by a rechargeable power supply 405, which supplies energy to all electrical and electronic components.

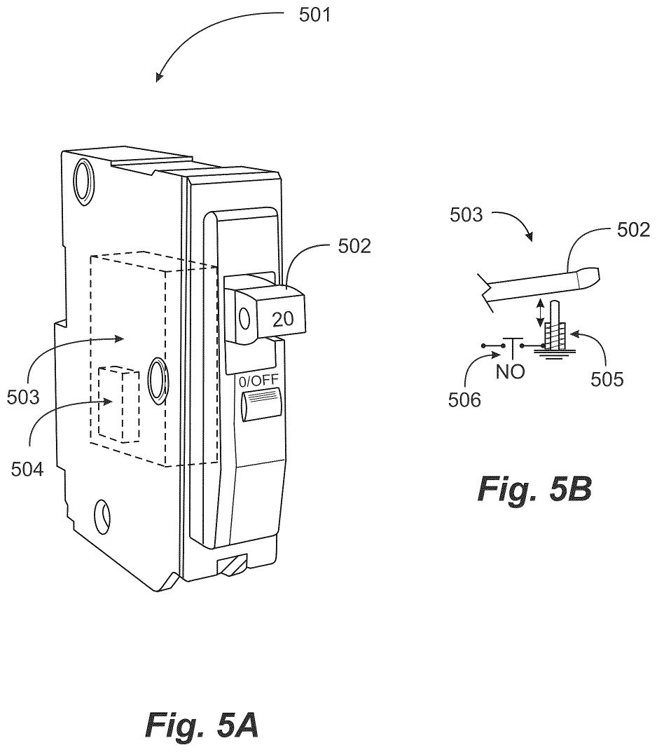

FIG. 5A provides a perspective view of a remotely operable circuit breaker 501. Externally, circuit breaker 501 resembles a conventional breaker, featuring a manually operable switch 502 for turning it on and off. However, it also includes internal apparatus 503, enabling remote operation. This apparatus incorporates electromagnetic communication circuitry 504, which allows breaker 501 to receive signals from a remote source, particularly circuit 404 in FIG. 4.

FIG. 5B details internal components of apparatus 503. Specifically, a solenoid-operated trigger 505 is controlled by a normally open (NO) contact 506, which activates in response to a remote signal received via electromagnetic communication circuitry 504. When NO contact 506 closes, solenoid trigger 505 forces switch 502 into the open position, cutting off power.

In one embodiment, a residential or commercial electrical circuit may be protected by a triggerable breaker 501, while current in the phase wire is monitored by a CT. If the measured current exceeds the breaker's rating, even when the breaker itself detects a lower current, a signal from wireless circuit 404 can trigger breaker 501 to open, preventing breaker masking and enhancing safety.

In another embodiment, a Breaker Masking Preventer (BMP) can be integrated into a junction box to monitor the internal values of more or all incoming and outgoing currents, including those from a connected Distributed Energy Resource (DER). Additionally, the system can monitor and regulate DER current and transmit remote alerts and control signals as required.

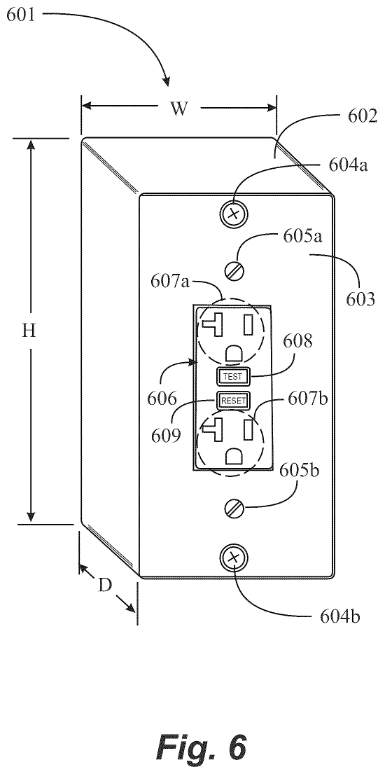

FIG. 6 illustrates an embodiment of BMP system 601, integrated into a specialized junction box 602. In this example, junction box 602 is a metal enclosure with a defined width (W), depth (D), and height (H), featuring a back panel and four sides, open at the front. In other embodiments, the junction box may be made of molded polymer or other materials. A front panel 603 is mounted onto shoulders (not shown) and secured using fasteners 604a and 604b.

Front panel 603 includes an opening for a dual receptacle 606, implemented as a Ground Fault Circuit Interrupter (GFCI). The GFCI breaker functionality might alternatively be integrated into the BMP controller circuits.

Bi-directional DER's like balcony solar units, portable solar generation devices and plug-in batteries would require bi-directional GFCI breaker circuits according to the latest National Electric Code in most cases.

This type of receptacle, well known in the industry, detects and interrupts current flow upon sensing a ground fault. The GFCI receptacle 606 is installed from behind panel 603, secured with fasteners 605a and 605b, and provides two receptacle interfaces, 607a and 607b, which accommodate connections for loads or, potentially, DERs contributing power to the circuit.

Junction box 602 is mounted onto a building wall and may be secured using fasteners through its back panel, attaching it directly to the wall structure or a supporting stud. If mounted on a cinder block or concrete wall, the junction box may be affixed using fasteners with anchors embedded in the masonry. A skilled artisan will recognize that a wider version of junction box 602 could accommodate two or more dual receptacles 606 side by side, offering expanded connectivity.

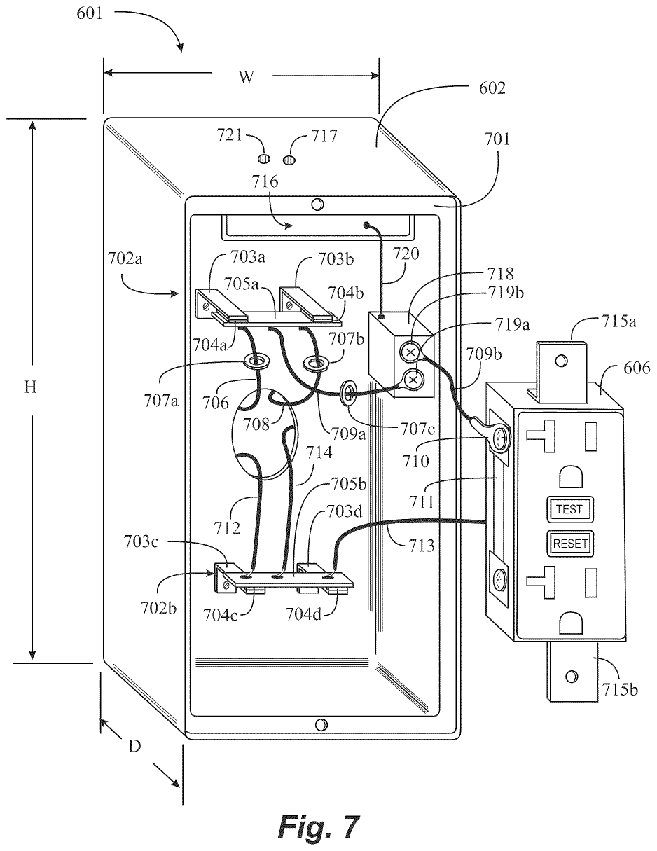

FIG. 7 provides a perspective view of BMP system 601 with the front panel 603 removed, exposing GFCI dual receptacle 606 and its internal wiring connections. Inside, a bus structure 702a is secured to the back panel of junction box 602 via brackets 703a and 703b. A phase current bus 705a is insulated from the brackets at both ends by non-conductive (insulator) panels 704a and 704b. The brackets 703a and 703b are fastened to the back panel of junction box 602 using conventional mounting hardware.

In this example, the incoming phase wire 706 passes through CT 707a before being soldered to the underside of bus 705a. While soldering is used here, alternative fastening methods such as screws or clamps may also be employed. The outgoing phase wire 708 is similarly soldered to the underside of bus 705a, passes through CT 707b, and exits the junction box toward a downstream destination.

Additionally, a separate phase wire 709a is soldered to the underside of bus 705a, passes through CT 707c, and connects to connector 719a, which is attached to the first terminal of a current-limiting device 718. This current-limiting device is mounted inside the junction box, affixed to a side wall in this example. The second terminal of current-limiting device 718 is connected via connector 719b to the dual receptacle 606, specifically at the phase input position, secured by connector 710. This connection supplies plug interface 607a (see FIG. 6).

A conductor strip 711 links the phase input terminals of the receptacle, eliminating the need for a separate wire for the second phase input that supplies plug interface 607b. Current-limiting device 718 is hard-wired to control circuitry 716 via conductor 720. The operation of this device is detailed further below.

In the lower section of the junction box, a second bus structure 702b supports a neutral bus 705b, mounted to the back wall via brackets 703c and 703d. The neutral bus 705b is insulated from the brackets using insulators 704c and 704d. The incoming neutral wire 712 is soldered to neutral bus 705b, as is the outgoing neutral wire 714.

A separate neutral wire 713 is soldered to bus 705b and connects to the neutral terminal of the receptacle 606 on the opposite side of the phase wire connections. The neutral terminals of the outlet receptacle connected by a conductive strip, allowing a single neutral wire from the neutral bus 705b to suffice for both plug interfaces. Junction box 602 includes a dedicated compartment in its upper section that houses control circuitry 716. This circuitry, described in further detail below, can include a rechargeable battery, which can be recharged via port 717, located on the top of the junction box.

A skilled artisan will recognize that the bus structures may be mounted in configurations different from those described in this embodiment. Similarly, CTs or similar current measurement devices 707a, 707b, and 707c may be secured using brackets or other mounting methods on any wall of the junction box. Each CT has dual-wire leads connected to control circuitry 716, though these connections are not shown in FIG. 7. These wires may be affixed to the walls of the junction box or routed in an alternative manner.

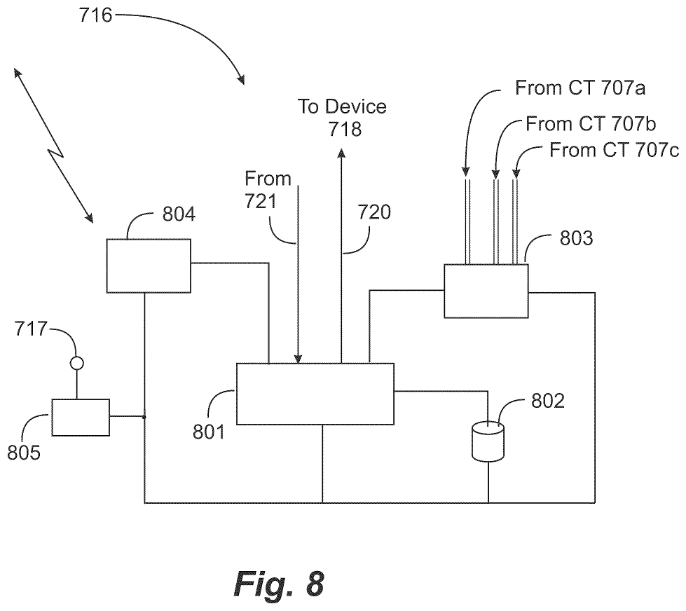

FIG. 8 illustrates an embodiment of control circuitry 716. In this example, processor 801 is connected to a digital data repository 802, which stores data and coded instructions. The processor is also linked to electromagnetic communication circuitry 804, enabling it to transmit and receive signals wirelessly from remote sites.

A monitoring circuit 803, connected to processor 801, receives voltage inputs from CTs 707a, 707b, and 707c. These voltage readings are used to calculate current values in the monitored phase wires, allowing for comparisons and additional computations. The system is powered by a rechargeable power supply 805, which provides energy to all circuitry components and can be recharged via port 717 (see FIG. 7).

A primary purpose of BMP 601 is to prevent breaker masking, which is defined above as allowing a current in a distribution circuit greater than the threshold of a breaker that provides power from the main to the circuit. Breaker masking is known to occur when a DER plugged into a receptacle provides additional current to a wire in the circuit above the breaker threshold, while the breaker “sees” only a current less than the breaker threshold.

It is well-known that circuit breakers of several different threshold values may be used in a breaker box to power different circuits. Common commercially available sizes are 15, 20, 30 and 40 amps. To be properly operable in different circuits, then, the BMP needs to operate conformal to the threshold of the circuit breaker that provides power to the circuit including the BMP. To accomplish this correspondence in one embodiment of the invention control circuitry 716 is provided configured to operate in accordance with a circuit breaker threshold. Thus there will be a BMP provided for a 15 amp circuit, another provided for a 20 amp circuit, yet another for a 30 amp circuit, and another for a 40 amp circuit, and a BMP may also be provided for any other circuit breaker threshold that a user may implement. A user is responsible for using the associated BMP with the known circuit threshold.

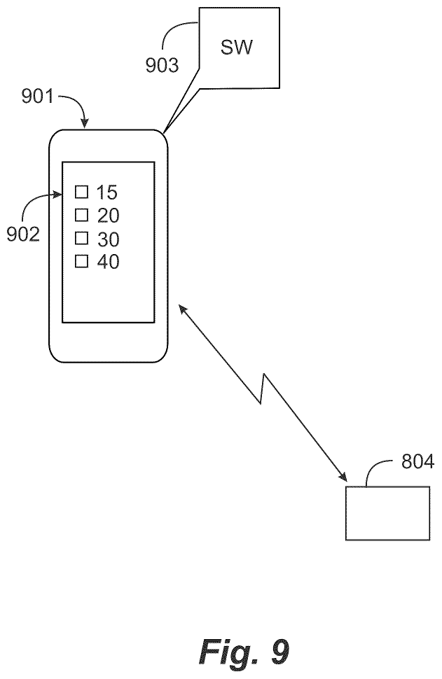

In an alternative embodiment, referring to FIG. 8 illustrating the control circuitry, electromagnetic communication circuitry 804 may be useful for programming the BMP to conform to the breaker threshold for a circuit. A mobile application may be provided for execution on a smart phone as illustrated in FIG. 9, whereby a BMP may be configured to conform to just one of the four breaker thresholds. Referring to FIG. 9, a smartphone 901 may execute a mobile app 903 which may present an interactive interface on a display 902 of the smartphone that may display alternatives for the operation of the BMP. In this example a user might check one of the four thresholds displayed, and the smartphone, coupled by a wireless protocol such as Bluetooth^{TM} to wireless circuitry 804 in the BPM, may configure the BMP to operate in a manner to be compatible with the threshold amperage of the circuit. In one circumstance the BMP is programmed to operate according to any one of the four common thresholds, and the selection simply enables the desired program.

In another alternative there may be a digital port 721 (see FIG. 7) which connects to processor 801 (see FIG. 8) such that a user may connect a simple device that enables the user to select by a switch input one of the four thresholds for operation of the BMP.

A general expression of operation of the BMP might be expressed as:

If i(out)>i(threshold) THEN dim OR disconnect DER OR trip remotely operable breaker. In this expression i represents current in amperes, and dim represents an action that diminishes a current value.

Referring now to FIG. 7, i(out) may refer to the current measured by CT 707b in the outgoing phase wire which might exceed the threshold for the circuit in a circumstance with a DER plugged into receptacle 606, as illustrated, for example, in FIG. 1. In a circumstance where the circuit is powered by a circuit breaker with a 15 amp threshold, a threshold for the BMP might well be set for 14.5 amps. If current measured by CT 707 b exceeds 14.5 amps, then, one of three different actions might be taken, as follows:
(1) Control circuitry 716 may operate a current limiter that is capable of diminishing the current from the DER to a value under the configurable threshold current. It is known that some DERs are configured to be remotely operated by electromagnetic signal to throttle the current provided by the DER. If such a DER is in use, processor 801 may signal the DER by wireless circuitry 804 to throttle the DER current until i(out) drops to or below the configurable threshold current. Another option may be that current limiter 718 is a device that perhaps switches resistance into the circuit. The inventor believes that using a DER that may be throttled by electromagnetic signal to be a preferable option, as a user would not have to manually reset circuit breakers.
(2) Control circuitry 716 may operate current limiter 718 to open a normally-closed contact to disconnect the DER current from receptacle 606.
(3) Control circuitry 716 may operate electromagnetic communication circuitry 804 to signal the circuit breaker powering the circuit to open. This circumstance requires that the circuit breaker be a remotely-operable circuit breaker as illustrated in FIGS. 5A and 5B, and described above with reference to FIGS. 5A and 5B.

In other circumstances in accordance with programming executed by processor 801 a user may monitor current in phase wire 709a measured by CT 707c, incoming current in phase wire 706 measured by CT 707a, or the processor may determine the difference between incoming and outgoing current.

A skilled person will understand that the more important current measurement is of the outgoing current from the junction box, which in embodiments described above is the current in the outgoing phase wire. But the purpose of the BMP might also be accomplished by measuring current in the outgoing neutral wire. So, in one embodiment of the invention the current sensors may be rearranged and the neutral wires may be connected to the current-limiting device in the junction box.

The skilled person will understand that the embodiments described herein are exemplary, and not limiting to the scope of the invention. There are a variety of alternative ways the apparatus may be configured and the functions may be accomplished within the scope of the invention. The scope is limited only by the claims.

1. A system, comprising:
a junction box;
at least one receptacle mounted to the junction box having a phase terminal and a neutral terminal;
a current limiting device having an input and an output terminal;
an incoming phase wire entering the junction box;
an incoming neutral wire entering the junction box;
an outgoing phase wire exiting the junction box, coupled to the incoming phase wire at a first junction;
an outgoing neutral wire exiting the junction box, coupled to the incoming neutral wire at a second junction ;
a first current sensor; and
control circuitry coupled to the first current sensor;
wherein the incoming terminal of the current limiting device is connected to one of the phase terminal and the neutral terminal of the at least one receptacle, the outgoing terminal of the current limiting device is connected to one of the first and the second junctions, and the first current sensor is associated with one of the outgoing phase wire and the outgoing neutral wire, and wherein the control circuitry, upon sensing a current by the current sensor above a preprogrammed threshold sends a signal to one of the current limiting devices, a distributed energy resource (DER) plugged into the at least one receptacle and a remotely operable circuit breaker.

2. The system of claim 1 wherein the incoming terminal of the current limiting device is connected to the phase terminal of the receptacle, the outgoing terminal of the current limiting device is connected to the first junction, and the first current sensor senses current in the outgoing phase wire.

3. The system of claim 2 wherein the DER is remotely operable, and wherein the control circuitry, upon sensing a current above a preprogrammed threshold sends a signal to the DER to reduce current until the sensed current above a preprogrammed threshold is at or below the preprogrammed threshold.

4. The system of claim 2 wherein the current limiting device is a device that limits current in an analog manner, and the control circuitry upon sensing a current above a preprogrammed threshold sends a signal to the current limiting device to reduce the current to a value below the preprogrammed threshold.

5. The system of claim 2 wherein the current limiting device is a normally closed contact, and the control circuitry upon sensing a current above a preprogrammed threshold sends a signal to the current limiting device to open the normally closed contact.

6. The system of claim 2 wherein, upon sensing a current above a preprogrammed threshold, the control circuitry transmits an electromagnetic signal to open a remotely operable circuit breaker.

7. The system of claim 1 wherein the incoming terminal of the current limiting device is connected to the neutral terminal of the receptacle, the outgoing terminal of the current limiting device is connected to the second junction, and the first current sensor senses current in the outgoing neutral wire.

8. The system of claim 7 wherein the current limiting device is a device that limits current in an analog manner, and the control circuitry upon sensing a current above a preprogrammed threshold sends a signal to the current limiting device to reduce the current to a value below the preprogrammed threshold.

9. The system of claim 7 wherein the current limiting device is a normally closed contact, and the control circuitry upon sensing a current above a preprogrammed threshold sends a signal to the current sensing device to open the normally closed contact.

10. The system of claim 7 wherein, upon sensing a current above a preprogrammed threshold, the control circuitry transmits a signal to open the remotely operable breaker.

11. The system of claim 1 further comprising a conductive phase bus with the incoming phase wire, the outgoing phase wire and a wire to the output terminal of the current limiting device all coupled to the phase bus.

12. The system of claim 11 wherein the wires are coupled to the phase bus by solder.

13. The system of claim 1 further comprising a conductive neutral bus with the incoming neutral wire, the outgoing neutral wire and a wire to the output terminal of the current limiting device all coupled to the neutral bus.

14. The system of claim 13 wherein the wires are coupled to the neutral bus by solder.

15. The system of claim 1 further comprising a second current sensor associated with one of the incoming phase wires and the incoming neutral wire.

16. The system of claim 1 wherein the first current sensor is a current transformer (CT).

17. The system of claim 15 wherein the second current sensor is a current transformer (CT).

18. The system of claim 1 wherein the at least one receptacle is a GFCI configured receptacle.

19. The system of claim 1 wherein the control circuitry is configured to operate on one of several different voltage thresholds, including 15 amps, 20 amps, 30 amps and 40 amps, depending on the threshold of a circuit breaker powering the circuit.

20. The system of claim 19 wherein the control circuitry is programmable by wireless signals from a smartphone executing a mobile application, to operate on a single one of different voltage thresholds.

21. The system of claim 19 wherein the control circuitry is programmable by a direct wire connection from a programming device, to operate on a single one of different voltage thresholds.
